(19) United States
(12) Patent Application Publication
(10) Pub. No.: US 2017/0038978 A1
(43) Pub. Date: Feb. 9, 2017

(54) Delta Compression Engine for Similarity Based Data Deduplication

(71) Applicant: HGST Netherlands B.V., Amsterdam (NL)

(72) Inventors: Dongyang Li, Kingston, RI (US); Qingbo Wang, Irvine, CA (US); Zvonimir Z. Bandic, San Jose, CA (US); Ken Qing Yang, Saunderstown, RI (US); Ashwin Narasimha, Los Altos, CA (US)

(21) Appl. No.: 15/214,243

(22) Filed: Jul. 19, 2016

Related U.S. Application Data
(60) Provisional application No. 62/201,493, filed on Aug. 5, 2015.

(51) Int. Cl. G06F 3/06

(52) U.S. Cl. CPC G06F 3/0608; G06F 3/0641; G06F 3/0661; G06F 3/067

(57) ABSTRACT

The present disclosure relates to systems and methods for similarity based data deduplications. The system may be realized as a delta compression engine using pipelining and parallel data lookup techniques across multiple hardware modules including a block sketch computation module, a reference block indexing module, and a similar block delta compression module. The system implements a method for delta compression including identifying an incoming data block among multiple reference data blocks in a reference dictionary to determine a near duplicate reference data block. The method may include looking up the incoming data block in a table built upon the reference data blocks. The method may further include representing the incoming data block in a final storage format as indices and lengths of the identified data equivalence in the corresponding reference data blocks.

### CROSS REFERENCE TO RELATED APPLICATIONS

The present application claims priority, under 35 U.S.C. §119, of U.S. Provisional Patent Application No. 62/201,493, filed Aug. 5, 2015 and entitled “Delta Compression Engine For Similarity Based Data Deduplication,” which is incorporated by reference in its entirety.

### FIELD OF THE INVENTION

The present disclosure relates to data compression techniques. In particular, the present disclosure relates to a hardware embodiment of a delta compression engine for similar chunks of data.

### BACKGROUND

Data deduplication techniques for improving storage utilization are becoming increasingly important due to explosive growth of data in the world of the Internet and enterprise backup environments. Data deduplication involves a data compression technique for eliminating redundant data and thus reducing the amount of storage space needed to save data. Data deduplication like other lossless compression techniques are used to reduce the amount of data transfer (e.g., data sent across a WAN for disaster recovery or remote backups) and data store (e.g., data retained on storage media such as tape or disk). Lossless compression techniques usually incur trade-offs between compression ratio and speed. Classic lossless compression algorithms such as LZ77 or LZO apply byte-level based searching of a dictionary and thus require a large DRAM resource as dictionary storage, which incurs a slower deduplication process. Snappy, an open source data compression algorithm written in C++, aims at achieving high speed rather than a maximized compression ratio. Other conventional deduplication technologies only look at identical data blocks, thus missing opportunities for compression where similar, non-identical, data blocks exist widely in data storage.

Data deduplication techniques have proven successful in backup systems where duplicate data blocks are prevalent, however, achieving the same success in primary storage, which is mainly used in a production environment, has proven challenging. One challenge involves achieving maximized compression ratio in primary storage where similar data blocks, as opposed to duplicate data blocks, are more prevalent. Another challenge involves improving performance where the required response time for each data unit in primary storage deduplication systems is much shorter than backup deduplication systems. An additional challenge involves the limitation of resources and the slowing down of application performance running on a server. While backup deduplication systems have their own resources, primary storage deduplication systems share resources such as the CPU and RAM utilized in the production environment, which could result in performance degradation of applications running on the server.

### SUMMARY

Systems and methods of a delta compression engine for similarity based data deduplication are disclosed. The present disclosure describes a delta compression engine including a block sketch computation module, a reference block indexing module, and a similar block delta compression module. The present disclosure further describes methods for delta compression.

Other embodiments of one or more of these aspects include corresponding systems, apparatus, and computer programs, configured to perform the actions of the methods, encoded on computer storage devices. It should be understood that the language used in the present disclosure has been principally selected for readability and instructional purposes, and not to limit the scope of the subject matter disclosed herein.

### BRIEF DESCRIPTION OF THE DRAWINGS

The present disclosure is illustrated by way of example, and not by way of limitation in the figures of the accompanying drawings in which like reference numerals are used to refer to similar elements.

FIG. 1 is a high-level block diagram illustrating an example system including a storage controller having a delta compression engine.

FIG. 2 is a block diagram illustrating an example system configured to implement the techniques introduced herein.

FIG. 3 illustrates a block diagram of an example hardware architecture and logical flow of a data through the delta compression engine, according to the techniques described herein.

FIG. 4 illustrates a two parallel pipeline structure design of the delta compression engine, according to the techniques described herein.

FIG. 5 is a flow chart of an example method for delta compression encoding a new reference data block, according to the techniques described herein.

FIG. 6 illustrates an example of delta compression encoding, according to the techniques described herein.

FIG. 7 illustrates a block diagram of a hardware decompression logic architecture, according to the techniques described herein.

FIG. 8 is a graphic representation of shingles in a data stream, according to the techniques described herein.

FIG. 9 is a graphic representation of an incremental computation pipeline design, according to the techniques described herein.

FIG. 10 is a block diagram illustrating an example block signature module, according to the techniques described herein.

FIG. 11 illustrates a parallel delta compression encoding structure, according to the techniques described herein.

### DETAILED DESCRIPTION

Systems and methods for implementing a pipelined hardware architecture of a delta compression engine for similarity based data deduplication are described below. While the systems and methods of the present disclosure are described in the context of a particular system architecture, it should be understood that the systems, methods and interfaces can be applied to other architectures and organizations of hardware.

A hardware implemented delta compression system and method are needed to provide line speed data deduplication, to improve latency and compression ratio over software delta compression engines running on servers, to improve throughput, to provide for better data reduction ratio over conventional techniques, and to make similarity based deduplication more applicable to primary storage or storage caches. The hardware implementation introduced herein provides for improved processing speed for data deduplication of similar data chunks. Delta compression may be processed in line speed, provide high throughput, and fast response time by means of pipelining and parallel data lookup across multiple hardware modules. Additionally, the hardware implementation introduced herein offers an offload of deduplication functions from servers so that application performance is not negatively affected. The hardware architecture introduced herein may be implemented on a field-programmable gate array (FPGA). However, the hardware architecture should not be limited to implementation on a FPGA. For example, the delta compression engine of the present disclosure may be implemented on other integrated circuits, such as an application-specific integrated circuit (ASIC).

Data deduplication is a data compression technique for improving storage utilization by eliminating redundant copies of data. Data deduplication techniques are also applicable to data transfer by reducing the size of data, e.g., the number of bytes, sent over a network. Data deduplication involves the identification and storage of unique blocks or chunks of data, e.g. byte patterns. Data deduplication systems work by retaining a single unique block of data on storage media, such as tape or disk, and referencing the single unique block of data for all data objects that include a matching block of data. A delta compression process as introduced herein may involve splitting a file into multiple chunks and generating a fingerprint for each chunk. The fingerprint may be a strong hash digest of the chunk. The delta compression process may further involve determining whether two fingerprints match. A new incoming chunk's fingerprint is compared to an existing chunk's fingerprint previously stored in the delta compression system. A determination that the two fingerprints match is an indicator that the contents of the chunks are duplicate or identical. If the two fingerprints match, only metadata for the new incoming chunk, such as a file name or logical block address (LBA) and a reference to the existing content, will be stored. For example, a redundant new incoming chunk is not retained however is replaced by a small pointer to the stored existing chunk. In another embodiment, a similar new incoming chunk is encoded and stored as a small pointer to a stored existing similar chunk and the difference in data between the new incoming chunk and the stored existing chunk. The terms block or chunk are used interchangeably in the present disclosure to refer to a basic unit of data deduplication. The terms block or chunk may refer to data of different sizes including, but not limited to, a file, data stream, or byte pattern.

Data blocks and files in primary storage are often modified by functions such as cut, insert, delete, and update and reassembled in different contexts and packages. Depending on the strength of a hash function used on a data block, a slightly modified data block may generate a different hash sketch. When a stronger has function is used, a slightly modified data block will generate a hash sketch different than the original data block. However, the different hash sketch will not be indexed and stored by a standard deduplication process, which is generally determined by the indication of a duplicate or identical match. If a weaker hash function is used on a slightly modified data block, the sketch of the modified block may be the same as the sketch of the pre-modified data block. The weaker hash sketches may include e.g. several Rabin fingerprints and have the property that if two data blocks share the same sketch, then the two data blocks contain a lot of the same content, i.e. the two data blocks are likely near-duplicate.

In similarity based deduplication using delta compression, a new incoming block is compared to a list of reference data blocks to identify a related reference data block by comparing their sketches. If a related reference data block is identified among the list of reference data blocks, a delta compression of the new incoming block is performed against the identified related reference data block and only the delta is stored along with a pointer to the identified related reference data block. By deriving the differences between near-duplicate data blocks, delta compression can effectively deduplicate data at both file or block levels. The central tenet of delta compression is to find the difference between two similar data blocks or chunks and try to retain only one of the two blocks in storage. The difference between the stored block and the remaining block along with a reference to the stored block is stored for the remaining block. Delta compression techniques offer deduplication benefit gains of 1.4 times compared to conventional deduplication techniques. However, improvements to the throughput of the system may be achieved through a hardware embodiment making the similarity based deduplicaiton techniques described in the present disclosure more applicable to primary storage or storage caches, (e.g., providing approximately one gigabyte per second throughput and a sub-millisecond in latency). embodiment

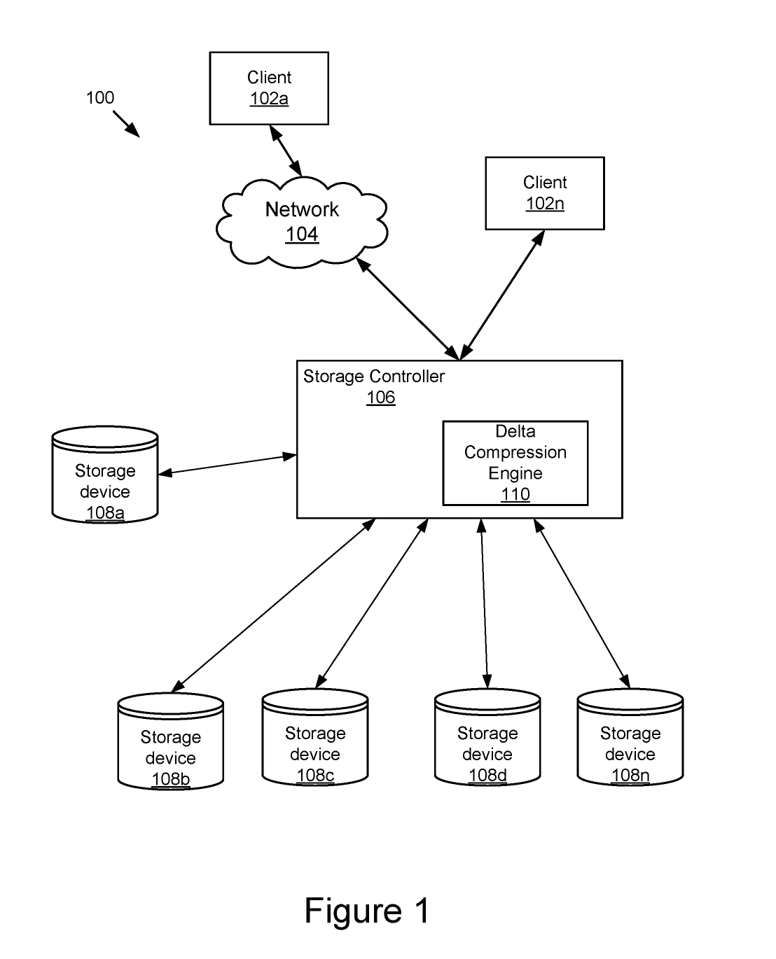

FIG. 1 is a high-level block diagram illustrating an example system 100 including a storage controller having a delta compression engine. The system 100 includes one or more clients 102a . . . 102n, a network 104, and a storage system including storage controller 106 and storage devices 108a . . . n. The storage controller 106 includes delta compression engine 110.

The client devices 102a . . . 102n can be any computing device including one or more memory and one or more processors, for example, a laptop computer, a desktop computer, a tablet computer, a mobile telephone, a personal digital assistant (PDA), a mobile email device, a portable game player, a portable music player, a television with one or more processors embedded therein or coupled thereto or any other electronic device capable of making storage requests. A client device 102 may execute an application that makes storage requests (e.g., read, write, etc.) to the storage devices 108. While the example of FIG. 1 includes two clients, 102a and 102n, it should be understood that any number of clients 102 may be present in the system. Clients (e.g., client 102a) may be directly coupled with storage sub-systems including individual storage devices (e.g., storage device 108a) via storage controller 106. Optionally, clients may be indirectly coupled with storage sub-systems including individual storage devices 108 via a separate controller.

In some embodiments, the system 100 includes a storage controller 106 that provides a single interface for the client devices 102 to access the storage devices 112 in the storage system. The storage controller 106 may be a computing device configured to make some or all of the storage space on disks 108 available to clients 102. As depicted in the example system 100, client devices can be coupled to the storage controller 106 via network 104 (e.g., client 102a) or directly (e.g., client 102n).

The network 104 can be one of a conventional type, wired or wireless, and may have numerous different configurations including a star configuration, token ring configuration, or other configurations. Furthermore, the network 104 may include a local area network (LAN), a wide area network (WAN) (e.g., the internet), and/or other interconnected data paths across which multiple devices (e.g., storage controller 106, client device 102, etc.) may communicate. In some embodiments, the network 104 may be a peer-to-peer network. The network 104 may also be coupled with or include portions of a telecommunications network for sending data using a variety of different communication protocols. In some embodiments, the network 104 may include Bluetooth (or Bluetooth low energy) communication networks or a cellular communications network for sending and receiving data including via short messaging service (SMS), multimedia messaging service (MMS), hypertext transfer protocol (HTTP), direct data connection, WAP, email, etc. Although the example of FIG. 1 illustrates one network 104, in practice one or more networks 104 can connect the entities of the system 100.

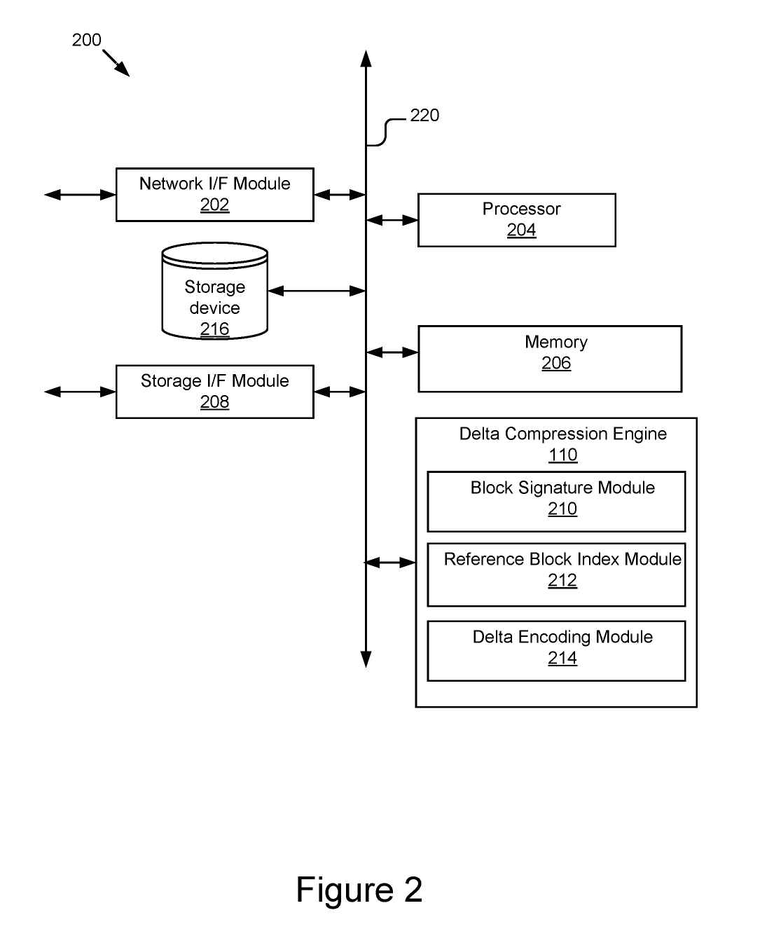

FIG. 2 is a block diagram illustrating an example system 200 configured to implement the techniques introduced herein. In one embodiment, the system 200 may be a client device 102. In other embodiments, the system 200 may be storage controller 106. In yet further embodiments, the system 200 may be implemented as a combination of a client device and storage controller 106.

The system 200 includes a network interface (IF) module 202, a processor 204, a memory 206, a storage interface (IF) module 208, a delta compression engine 110, and a storage device 216. Delta compression engine 110 includes block signature module 210, a reference block index module 212, and a delta encoding module 214. The components of the system 200 are communicatively coupled to a bus or software communication mechanism 220 for communication with each other.

In some embodiments, software communication mechanism 220 may be an object bus (e.g., CORBA), direct socket communication (e.g., TCP/IP sockets) among software modules, remote procedure calls, UDP broadcasts and receipts, HTTP connections, function or procedure calls, etc. Further, any or all of the communication could be secure (SSH, HTTPS, etc.). The software communication mechanism 220 can be implemented on any underlying hardware, for example, a network, the Internet, a bus, a combination thereof, etc.

The network interface (I/F) module 202 is configured to connect system 200 to a network and/or other system (e.g., network 104). For example, network interface module 202 may enable communication through one or more of the internet, cable networks, and wired networks. The network interface module 202 links the processor 204 to the network 104 that may in turn be coupled to other processing systems (e.g., a server). The network interface module 202 also provides other conventional connections to the network 104 for distribution and/or retrieval of files and/or media objects using standard network protocols such as TCP/IP, HTTP, HTTPS and SMTP as will be understood. In some embodiments, the network interface module 202 includes a transceiver for sending and receiving signals using WiFi, Bluetooth® or cellular communications for wireless communication.

The processor 204 may include an arithmetic logic unit, a microprocessor, a general purpose controller or some other processor array to perform computations and provide electronic display signals to a display device. In some embodiments, the processor 204 is a hardware processor having one or more processing cores. The processor 204 is coupled to the bus 220 for communication with the other components. Processor 204 processes data signals and may include various computing architectures including a complex instruction set computer (CISC) architecture, a reduced instruction set computer (RISC) architecture, or an architecture implementing a combination of instruction sets. Although only a single processor is shown in the example of FIG. 2, multiple processors and/or processing cores may be included. It should be understood that other processor configurations are possible.

The memory 206 stores instructions and/or data that may be executed by the processor 204. The memory 206 is coupled to the bus 220 for communication with the other components of the system 200. The instructions and/or data stored in the memory 206 may include code for performing any and/or all of the techniques described herein. The memory 206 may be, for example, non-transitory memory such as a dynamic random access memory (DRAM) device, a static random access memory (SRAM) device, flash memory or some other memory devices. In some embodiments, the memory 206 also includes a non-volatile memory or similar permanent storage device and media, for example, a hard disk drive, a floppy disk drive, a compact disc read only memory (CD-ROM) device, a digital versatile disc read only memory (DVD-ROM) device, a digital versatile disc random access memories (DVD-RAM) device, a digital versatile disc rewritable (DVD-RW) device, a flash memory device, or some other non-volatile storage device.

The storage interface (I/F) module 208 accesses information requested by the clients 102. The information may be stored on any type of attached array of writable storage media, such as magnetic disk or tape, optical disk (e.g., CD-ROM or DVD), flash memory, solid-state drive (SSD), electronic random access memory (RAM), micro-electro mechanical and/or any other similar media adapted to store information, including data and parity information. However, as illustratively described herein, the information is stored on disks 108. The storage I/F module 208 includes a plurality of ports having input/output (I/O) interface circuitry that couples with the disks over an I/O interconnect arrangement.

In some embodiments, the delta compression engine 110 of system 200 may be configured to compress data for storage or transfer based on a delta compression similarity based data deduplication technique in accordance with the present disclosure. Delta compression engine 110 may include block signature module 210, reference block index module 212, and delta encoding module 214. In one embodiment, the block signature module 210 may be configured to compute signature sketches for data blocks based on a fingerprint computation. The signature sketches may be determined according to any generally known fingerprint computation. An exemplary fingerprint computation is described in accordance with the present disclosure. In one embodiment, the block signature module 210 may be configured to determine the signature sketches of new incoming data blocks based on a fingerprint computation. In another embodiment, the block signature module may be configured to determine the signature sketches of data blocks that will be stored in a reference list table or dictionary of reference data blocks.

In some embodiments, the reference block index module 212 is in communication with the block signature module 210 to receive signature sketches determined by the block signature module 210. The reference block index module 212 may be configured to generate and search a reference index and reference dictionary using a determined block signature sketch, according to techniques disclosed herein, in order to identify related reference data blocks that may be used as a basis for delta compression. The reference block index module 212 may access, store, generate, and/or manage a reference index containing reference fingerprints or signature sketches (computed by the block signature module 210) against which new incoming fingerprints may be compared. The reference block index module 212 may be configured to compare a newly generated fingerprint to indexed fingerprints to identify a similar reference data block.

In some embodiments, the delta encoding module 214 compares an incoming data block corresponding with the newly generated fingerprint to a related reference data block stored among reference data blocks. For example, the delta encoding module 214 scans the incoming data block and the reference data block to determine a match between one or more data elements of the data blocks. The delta encoding module 214 encodes the new data block using matching data elements between the new data block and the reference data block to produce a compressed delta.

The block signature module 210, the reference block index module 212, and the delta encoding module 214 may be implemented in hardware, e.g. on a field programmable gate array (FPGA), an application specific integrated circuit (ASIC), or the like. For example, the modules 210, 212, and 214 may be implemented on a V6-240T FGPA, or the like, and act as a co-processor in system 200. While depicted in FIGS. 2 as distinct modules, it should be understood that one or more of the modules 210, 212, and/or 214 may be implemented on the same hardware device or various hardware devices.

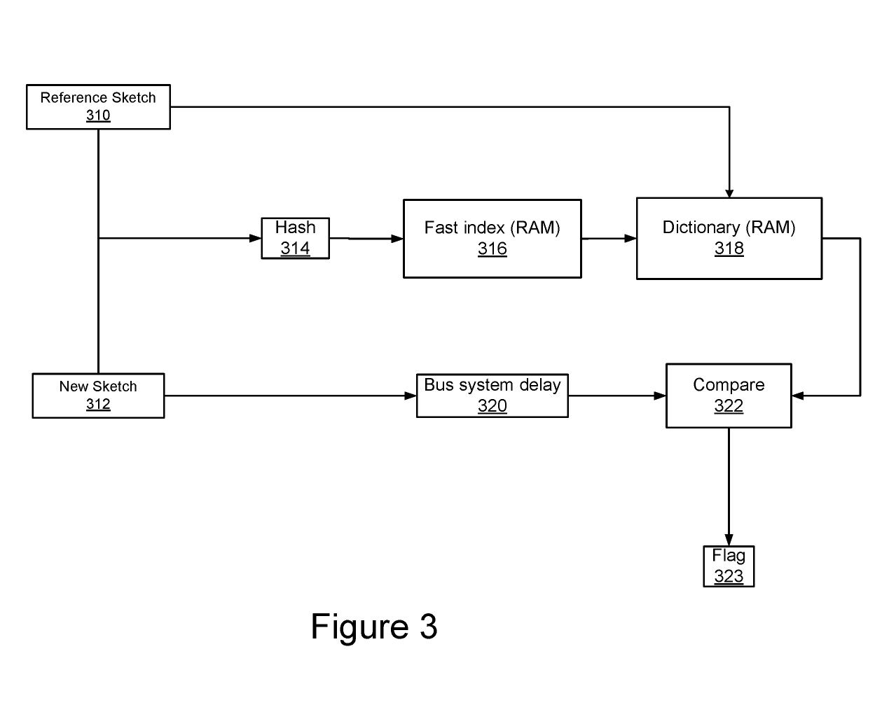

FIG. 3 illustrates a block diagram of an example hardware architecture and logical flow of a data through the delta compression engine in accordance with the present disclosure. Reference sketches 310 are loaded into dictionary 318. Dictionary 318 is a reference list table built up of reference data blocks associated with their fingerprint sketches (e.g., reference sketches 310). Dictionary 318 may be stored in random-access memory (RAM). Fast index 416 is a hash index table. A hash function 314 is performed on each reference sketch and a hash index table is built up of hash key records, where each record forms a pair composed of a hash key and an index to the reference list. The hash index table may be stored in RAM. After the fast index 316 and dictionary 318 are built up, a new sketch 312 is received and a hash function 314 is performed on the new sketch 312. A hash key of the new sketch 314 is used to search fast index 416 for a similar hash key of a related reference sketch in one of the hash index records of fast index 416. If a matching hash key is found, the hash key record including an index to the reference list is used to locate a related reference sketch and its corresponding related reference data block in the dictionary 318. After a bus system delay 320 to account for the hash function 314 and index search on the new sketch 312, the new data block corresponding to new sketch 312 is compared at 322 to the related reference data block corresponding to the related reference sketch. While scanning the new data block and the related reference data block, a flag 323, is set based on a determination of a match between one or more data elements of the new data block and one or more data elements of the related reference data block. The new data block is delta compressed against the related reference data block and stored according to an encoding scheme using the match.

In one embodiment, a reference sketch 310 and a new sketch 312 are received by delta compression engine. A sketch may be used to represent each data block and keep track of I/O access patterns to all sketches. The reference block index module 212 may be configured to generate dictionary 318 by storing reference data blocks and their sketches in a reference list. For example, based on content locality, access frequency, and/or recency of data contents, some of the most popular data blocks are selected and cached in dictionary 318 as reference data blocks in a reference list. A newly generated block sketch, e.g. new sketch 312, is used as key to search the reference list of dictionary 318 to find a related reference data block in the reference list. The new data block corresponding to the new sketch 312 is compared to the related reference data block and then delta compressed against the related reference data block to produce a compressed delta. The compressed delta and a pointer to the related reference data block are stored in primary storage or cache.

In one embodiment, a sketch contains 8 fingerprints each of which is one byte long. If a reference data block has n fingerprints that match between their respective sketches (n from 4 to 8), the two data blocks are considered near duplicate blocks. n is referred to as a similarity threshold. Once a near duplicate block is found in the reference index, i.e. fast index 416, using a hash 314 of the new sketch 312 as key, the corresponding reference data block will be read out of the dictionary and delta compression will be performed against it.

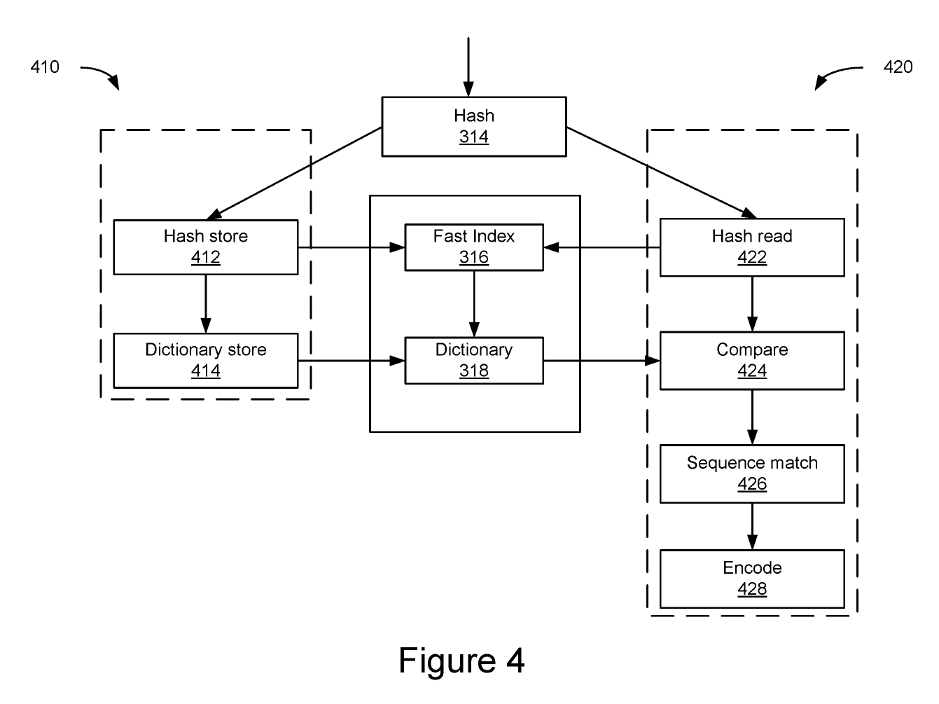

FIG. 4 illustrates a two parallel pipeline structure design of the delta compression engine which may be employed according to the present disclosure. As seen in FIG. 4, one pipeline, e.g., reference pipeline 410, is used to build the dictionary using the reference data block while the other pipeline, e.g., compression pipeline 420, scans an incoming data block to be compressed.

In one embodiment, the reference pipeline 410 processes reference data blocks (e.g., data blocks determined to be frequently or recently accessed) to load the reference data blocks into the dictionary 318. For example, at 412 portions of the reference data block (e.g., 8 byte portions shifted 1 byte at a time), are hashed into a hash value that is used to search for a matching string in dictionary 318. To avoid linear search of the dictionary 318, another block RAM may be used to build a fast index 316.

The compression pipeline 420 processes an incoming new data block such that a quick search for repeated strings may be performed through the fast search structure. For example, an incoming new data block is hashed into a hash value that is used as a key to search at 422 for a related reference data block in dictionary 318. In some embodiments, a bitwise comparison may be performed to confirm a bit-by-bit match of the two strings. Once a match is found at 424, a sequential search at 423 is performed to maximize the match length. The search results are then encoded at 428.

In one embodiment, a sequential search may be performed by an address prediction technique in order to optimize the length of the matched data string and maximize the compression ratio. Using the address prediction technique, when a match is found, the delta encoding module 214 will predict the next matching dictionary index location is the location directly after the current location, and will not search the dictionary by the hash key value for the next match.

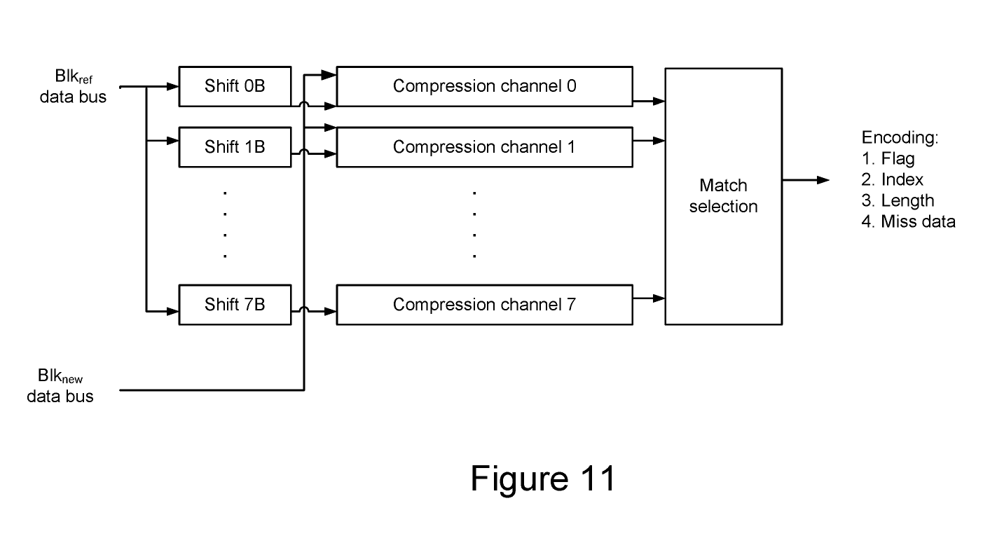

The compression hardware of the present disclosure is further optimized to have wire speed compression by the design of a parallel delta compression encoding structure as seen in FIG. 11. Generally, string matching is done for every 8 byte data chunk where subsequent data chunks in a data block are shifted by just one byte at a time. In one embodiment, the bus width is 8 bytes, so the data transfer speed of the bus may be faster than one delta compression engine. Therefore, some embodiments include eight compression channels working in parallel to achieve wire speed. In one embodiment, each channel stores and encodes one data chunk.

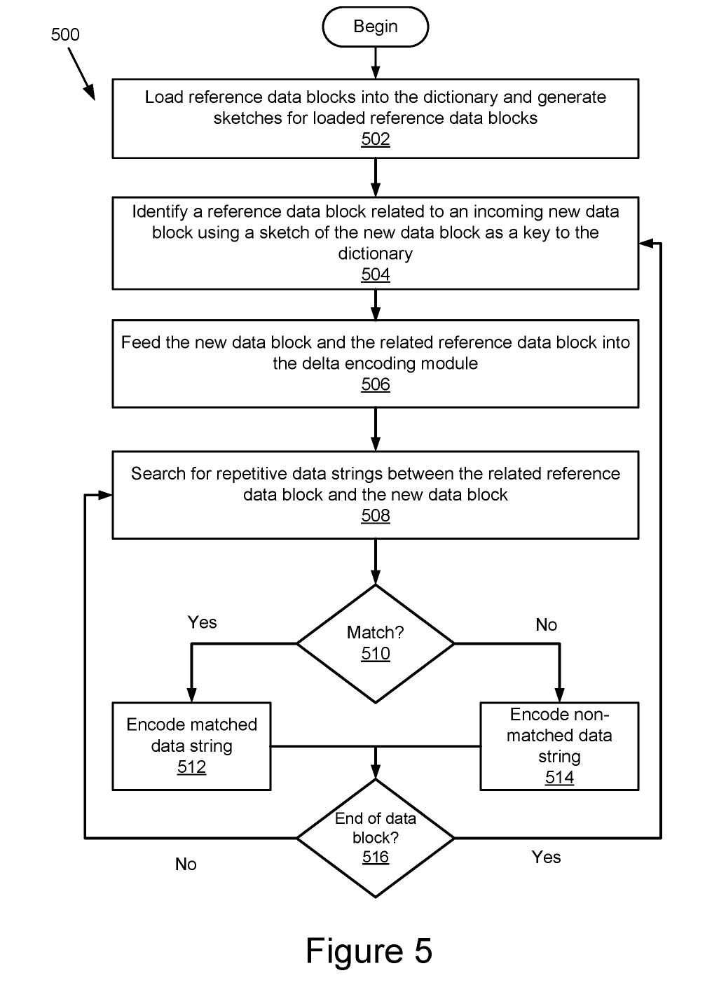

FIG. 5 is a flow chart of an example method for delta compression encoding a new reference data block. At 502, reference data blocks are loaded into dictionary 318 and sketches are generated for the loaded reference data blocks. As described above, a sketch of a reference data block is generated by the block signature module 210 creating a group of fingerprints characterizing the data of the reference data block. In one embodiment, the reference data blocks are chosen based on how frequently and/or recently the data blocks have been accessed. At 504, the reference block index module 212 identifies a reference data block related to an incoming new data block using a sketch of the new data block as a key to the dictionary 318. In some embodiments, the reference block index module 212 further uses a fast hash index 416 as described above. At 506, the new data block and the identified related reference data block are fed into delta encoding module 214. At 508, the delta encoding module 214 scans the related reference data block and the new data block for repetitive or matching data strings or data elements. At 510, if the delta encoding module 214 finds a match between one or more data elements of the new data block and the related reference data block, the matched data elements of the new data block are encoded 512 according to the encoding output structure for matched data elements as described herein. If, at 510, the delta encoding module 214 does not find a match between one or more data elements or data string of the new data block, the non-matched data elements or data string is encoded 514 according to the encoding output structure for non-matched data elements as described herein. After encoding matched 512 or non-matched 514 data elements or data strings, the encoding module 214 determines if the end of the new data block has been reached 516, the process returns to 504 where a new data block will be encoded. If, at 516, the end of the new data block has not been reached, the method continues 508 to scan the new data block and the related reference data block for matching data elements or data strings in order to encode the remaining data elements of the new data block.

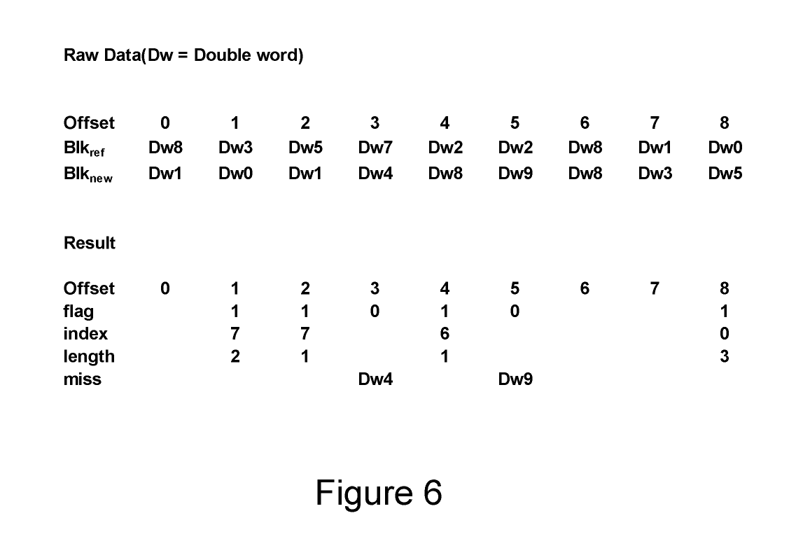

FIG. 6 illustrates an example of delta compression encoding according to the techniques disclosed herein. Throughout the description of FIG. 6, Blk_{ref} is used to refer to a related reference data block and Blk_{new} is used to refer to a new data block to be compressed using the related reference data block. As described above, the related reference data block is loaded into the dictionary prior to receiving the new data block for compression. As described above, the delta encoding module 214 compares the two data blocks to determine repetitions between the two data blocks. The encoded data includes a number of fields to identify matched or non-matched data elements and locations to where the data elements can be found on storage media. For example, the fields may include an offset, a flag, an index, and a length. The offset field indicates the position of a data element in the new data block or the related reference data block. For example, when data elements in the new data block and the related reference data block match, the offset field indicates the ending position of the matched one or more data elements in the new data block. Similarly, when a data element in the new data block does not match, the offset field indicates the position of the data element in the new data block that did not match a data element in the related reference data block. The flag field indicates whether a data element in the new data block has a match in the related reference data block. For example, the flag field may be set to 1 if a match is found in the related reference data block for a data element of the new data block and may be set to 0 if no match is found. The index field indicates the starting position of the matched string in the related reference data block. The length field indicates the total length of the matched string. The miss field indicates the data elements from the new data block which do not appear in the related reference data block (e.g., when the flag field is set to 0). For example, the miss field may store a physical or logical address for the data elements stored to a storage device.

As illustrated in the example of FIG. 6, data elements 0 and 1 (Dw1 and Dw0) of new data block Blk_{new} match data elements 7 and 8 (Dw1 and Dw0) of the related reference data block Blk_{ref}. The fields of the encoded data are set to indicate the data elements of the new data block that match the related reference data block (e.g., offset=1) whether a match is found (e.g., flag=1) the starting position of the matched data in the related reference data block (e.g., index=7), and the length of the matching data elements in the related reference data block Blk_{ref} (e.g., length=2). Thus, the output for the above described match may be encoded as (1,1,7,2) with a reference to the related reference data block, as shown in the example of FIG. 6. Similarly, the example encoding of FIG. 6 shows data element 3 (e.g., Dw4) in Blk_{new} has no match in Blk_{ref}, therefore, the fields of the encoded data indicate that the data element (e.g., offset=3) of the new data block does not have a match (e.g., flag=0), and includes a reference to the unique data (e.g., Dw4) stored on a storage device. As shown in the example of FIG. 6, the output may be encoded as (3,0, Dw4).

Algorithm 1 below shows the process for single dictionary encoding.

Algorithm 1: Single dictionary encoding

```
if reference block then
    for i=block size-7 to 0 do
        Dictionary [i] = Blk_{ref} [i, i+1..., i+7]
        Hash table [hash_func (Blk_{ref} [i, i+1..., i+7]) ] = i
    end for
else
    for i=block size/8 to 0 do
        Hash_index = Hash table [hash_func(Blk_{new} [i×8..., i×8+7])
        String match with Dictionary [Hash_index]
        Encoding
    end for
end if
```

For single dictionary encoding, a line speed of 8 byte encoding is possible.

In some embodiments, both reference data block dictionary updating and new data block delta encoding can be processed in line speed by parallel computation in hardware design. Algorithm 2 below shows the process for multiple dictionary encoding where a single large dictionary may be split into 8 smaller dictionaries such that multiple dictionaries may perform parallel store and search.

Algorithm 2: Multiple dictionary encoding

```
if reference block then
    for m=8 to 0 do
        for i=block size/8 to 0 do
        Dictionary [m][i] = Blk_{ref} [i+m..., i+m+7]
        Hash table [m][hash_func (Blk_{ref} [i+m..., i+m+7]) ] = i
        end for
    end for
else
    for m=8 to 0 do
        for i=block size/8 to 0 do
        Hash_index [m] =Hash table [hash_func(Blk_{new} [i×8..., i×8+7])
        String match with Dictionary [m][Hash_index[m]]
        Encoding
        end for
    end for
end if
```

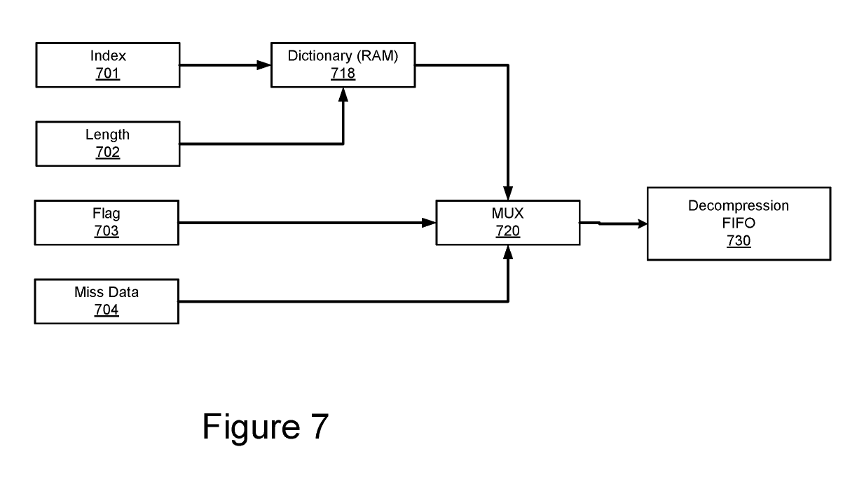

FIG. 7 illustrates a block diagram of a hardware decompression logic architecture. Based on the value of flag 703, a multiplexor (MUX) 720 selects either the value from dictionary 718 or miss 704 and sends the selected value to decompression FIFO 730 for recovery of the delta compressed data. In one embodiment, the dictionary 718 or miss 704 stores a reference to data stored elsewhere and provides the reference to the decompression FIFO 730. The value of flag 703 is determined by whether a string in a delta compressed data block has a match in a related reference data block. If there is a match, (e.g., flag 703 holds the value 1), index 701 and length 702 are used to produce the data stream or corresponding data elements from the dictionary 718. If there is no match (e.g., flag 703 holds the value 0), the MUX 720 will forward the input from miss data 704 to the decompression FIFO to retrieve the data for the delta compressed data block. The value of miss data 704 refers to the value of the data element in a delta compressed data block that did not have a match to a data element in a related reference data block.

In some embodiments, data block sketches, e.g. reference sketch 310 and new sketch 312, are derived by a Rabin fingerprint calculation for every fix-sized sliding window (e.g. 8 bytes long). In some embodiments, the block signature module 210 processes multiple bits in one clock cycle to provide fingerprinting for high data rate applications. Using formal algebra, a single modulo operation (e.g., determining a Rabin fingerprint) can be turned into multiple calculations, each of which is responsible for one bit in the result. In the following examples, we assume the data string is 64 bits resulting in 16-bit Rabin fingerprints.

In one embodiment, to implement one of these equations in hardware, a combinatorial circuit may be used to computer an exclusive-OR (XOR) all of the corresponding input bits. The combination of these 16 circuits is referred to herein as a Fresh function.

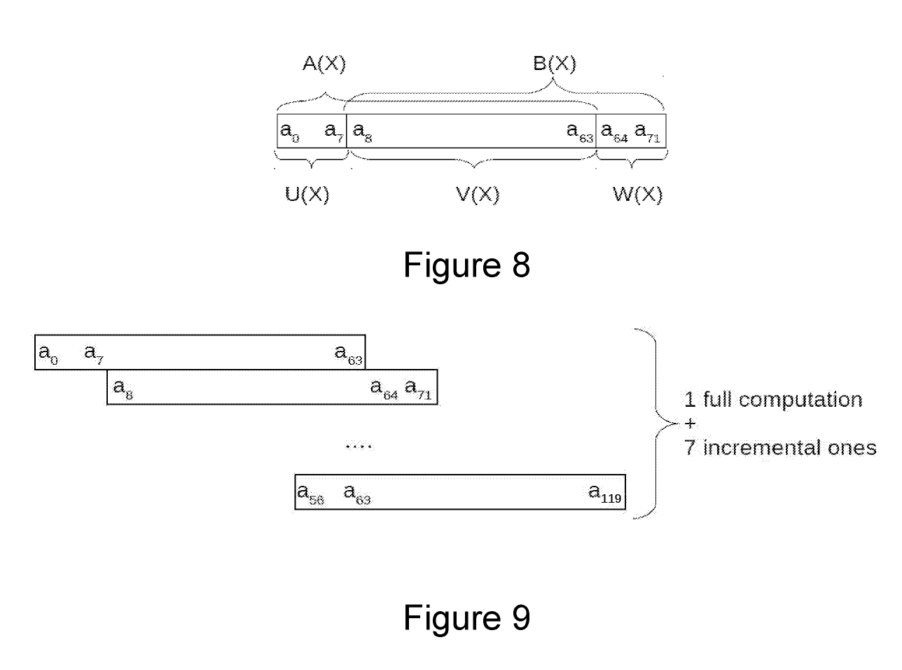

For applications of higher data rate, Rabin fingerprint computations are applied to all “shingles.” An example of these shingles is shown in FIG. 8. FIG. 8 depicts shingles in a data stream from α0 to α71, where (X) is the first shingle, and (X) is the second shingle. While the example of FIG. 8 depicts a shift of one byte, shingles can shift in various other multiples of bits. In one embodiment, to treat all of the shingles in real-time, the Fresh function may be replicated over each shingle. However, it is evident that overlapping computations occur in this scheme. The relation between the Rabin fingerprints of A and B can be calculated as:

Bmod P=(V+W·X⁵⁶)mod P

Bmod P=((U−U)·(X⁻⁸ mod P)+V+W·X⁵⁶)mod P

Bmod P=(−U·(X⁻⁸ mod P))mod P+((X⁻⁸ mod P)·(U+V·X⁸))mod P+(W·X⁵⁶)mod P

Bmod P=(W·X⁵⁶−U·(X⁻⁸ mod P))mod P+((X⁻⁸ mod P)·(U+V·X⁸))mod P

Bmod P=(W·X⁵⁶−U·(X⁻⁸ mod P))mod P+((X⁻⁸)mod P)·(U+V·X⁸)mod P)mod P

Let x⁻⁸ =X⁻⁸ mod P

B mod P=(W·X⁵⁶−U·x⁻⁸)mod P+(x⁻⁸·A mod P)mod P

As can be seen, the fingerprint of the new shingle B(x) is dependent on the fingerprint of the old shingle A(x), the first byte of the old shingle U(x), and the first byte of incoming data W(x), which is the last byte of the new shingle B(x). Thus, the fingerprint calculation of each shingle can be optimized using the fingerprint calculation of the previous shingle.

Using a 64-bit wide data bus and a 64-bit shingle as an example, an incremental computation pipeline design is illustrated in FIG. 9. The data is drawn from two consecutive clock cycles, for example (α0, α1 , . . . , α63) from the preceding cycle and (α64, α65, . . . α127) from the following cycle.

In some embodiments, the techniques disclosed herein include finding an irreducible polynomial for which Rabin fingerprint computation has the least amount of operations for one full computation and several incremental computations of a multiple byte data shingle to group the data in a stream (e.g., seven incremental computations for an eight byte data shingle). The techniques further include computing a Rabin fingerprint incrementally using the selected irreducible polynomial. For example, incremental computation may allow computation of a fingerprint to reuse calculations results from a previous fingerprint calculation of eight bytes. As an example, the fingerprint calculation may calculate the fingerprint of all eight bytes numbered zero to seven, and may shift one byte to the right for a next clock cycle. On the next clock cycle the calculations for bytes zero to seven may be reused and the calculations involving byte eight, and byte zero may be performed. Thus, the fingerprint for the shingle of bytes one to eight may be performed incrementally, reusing the calculations of the prior fingerprint for eight bytes and performing new calculations.

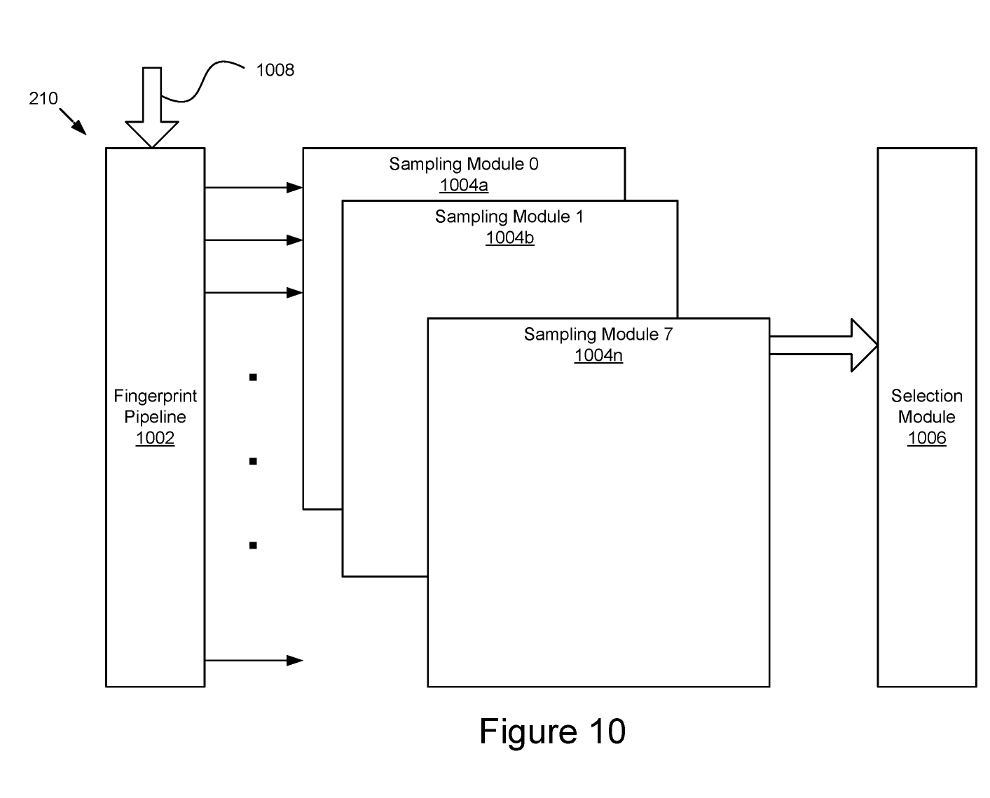

FIG. 10 is a block diagram illustrating an example block signature module 210. The example block signature module 210 includes a fingerprint pipeline 1002, a number of sampling modules 1004a-1004n, and a fingerprint selection module 1006. In the example single pipeline design depicted in FIG. 10, data 1008 flows from top to bottom through the fingerprint pipeline. The total number of fingerprints generated for a w-byte data chunk according to the techniques disclose here is w−b+1, where b is the size of the shingles. In some embodiments, to reduce the number of fingerprints compared by the deduplication modules, several fingerprints may be chosen from among all of the fingerprints as a sketch to represent the data chunk. In one embodiment, fingerprints with upper N bits having a specific pattern are selected for the sketch since these upper bits in each fingerprint can be considered as randomly distributed. The result of this selection is a good choice in terms of balancing processing speed, similarity detection, elimination of false positives, and resolution.

Fingerprint results produced at every pipeline stage are sent to the right for the corresponding channel sampling modules to process. As the data chunk runs through the pipeline, the fingerprints are sampled and stored in an intermediate buffer. After the sampling for a data chunk is done, the fingerprint selection module will choose from the intermediate samples and returns a sketch for the data block. In some embodiments, the pipeline is composed of one Fresh function and several following Shift functions.

Systems and methods for implementing a hardware architecture of a delta compression engine for similarity based data deduplications are described below. In the above description, for purposes of explanation, numerous specific details were set forth. It will be apparent, however, that the disclosed technologies can be practiced without any given subset of these specific details. In other instances, structures and devices are shown in block diagram form. For example, the disclosed technologies are described in some embodiments above with reference to user interfaces and particular hardware. Moreover, the technologies disclosed above primarily in the context of on line services; however, the disclosed technologies apply to other data sources and other data types (e.g., collections of other resources for example images, audio, web pages).

Reference in the specification to “one embodiment” or “an embodiment” means that a particular feature, structure, or characteristic described in connection with the embodiment is included in at least one embodiment of the disclosed technologies. The appearances of the phrase “in one embodiment” in various places in the specification are not necessarily all referring to the same embodiment.

Some portions of the detailed descriptions above were presented in terms of processes and symbolic representations of operations on data bits within a computer memory. A process can generally be considered a self-consistent sequence of steps leading to a result. The steps may involve physical manipulations of physical quantities. These quantities take the form of electrical or magnetic signals capable of being stored, transferred, combined, compared, and otherwise manipulated. These signals may be referred to as being in the form of bits, values, elements, symbols, characters, terms, numbers or the like.

These and similar terms can be associated with the appropriate physical quantities and can be considered labels applied to these quantities. Unless specifically stated otherwise as apparent from the prior discussion, it is appreciated that throughout the description, discussions utilizing terms for example “processing” or “computing” or “calculating” or “determining” or “displaying” or the like, may refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosed technologies may also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, for example, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The disclosed technologies can take the form of an entirely hardware embodiment, an entirely software embodiment or an embodiment containing both hardware and software elements. In some embodiments, the technology is implemented in software, which includes but is not limited to firmware, resident software, microcode, etc.

Furthermore, the disclosed technologies can take the form of a computer program product accessible from a non-transitory computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

A computing system or data processing system suitable for storing and/or executing program code will include at least one processor (e.g., a hardware processor) coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the processes and displays presented herein may not be inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the disclosed technologies were not described with reference to any particular programming language. It will be appreciated that a variety of programming languages may be used to implement the teachings of the technologies as described herein.

The foregoing description of the embodiments of the present techniques and technologies has been presented for the purposes of illustration and description. It is not intended to be exhaustive or to limit the present techniques and technologies to the precise form disclosed. Many modifications and variations are possible in light of the above teaching. It is intended that the scope of the present techniques and technologies be limited not by this detailed description. The present techniques and technologies may be implemented in other specific forms without departing from the spirit or essential characteristics thereof. Likewise, the particular naming and division of the modules, routines, features, attributes, methodologies and other aspects are not mandatory or significant, and the mechanisms that implement the present techniques and technologies or its features may have different names, divisions and/or formats. Furthermore, the modules, routines, features, attributes, methodologies and other aspects of the present technology can be implemented as software, hardware, firmware or any combination of the three. Also, wherever a component, an example of which is a module, is implemented as software, the component can be implemented as a standalone program, as part of a larger program, as a plurality of separate programs, as a statically or dynamically linked library, as a kernel loadable module, as a device driver, and/or in every and any other way known now or in the future in computer programming. Additionally, the present techniques and technologies are in no way limited to embodiment in any specific programming language, or for any specific operating system or environment. Accordingly, the disclosure of the present techniques and technologies is intended to be illustrative, but not limiting.

What is claimed is:

1. A system comprising:
a block signature module configured to determine a signature sketch of a new data block based on a fingerprint computation;
a reference block index module communicatively coupled to the block signature module, the reference block index module configured to:
receive, from the block signature module, the signature sketch of the new data block;
compute a new hash key of the signature sketch of the new data block;
search a hash index table using the new hash key to find a reference hash index record including a reference hash key similar to the new hash key;
search a reference list table, using the reference hash index record, to determine a signature sketch of a related reference data block stored in the reference list table;
retrieve, from the reference list table, the related reference data block corresponding to the signature sketch of the related reference data block responsive to determining that a similarity between the signature sketch of the new data block and the signature sketch of the related reference data block exceeds a threshold;
a delta encoding module communicatively coupled to the reference block index module, the delta encoding module configured to:
scan the related reference data block and the new data block to determine a match between one or more data elements of the related reference data block and one or more data elements of the new data block; and
to encode the one or more data elements of the new data block using the match to produce a compressed delta.

2. The system of claim 1, wherein the reference block index module is further configured to:
store, in the reference list table, a plurality of reference data blocks and a corresponding signature sketch of each of the plurality of reference data blocks.

3. The system of claim 1, wherein the delta encoding module is further configured to:
compare the one or more data elements of the related reference data block and the one or more data elements new data block to determine an identical match; and
responsive to determining an identical match, sequentially search the related reference data block and the new data block to determine the length of the identical match.

4. The system of claim 2, wherein the a reference block index module and the delta encoding module are configured in parallel pipeline structure to:
store, in the reference list table, the plurality of reference data blocks and each corresponding signature sketch; and
encode the one or more data elements of the new data block.

5. The system of claim 1, wherein the compressed delta comprises:
an offset field, wherein the offset indicates the ending position of the matched one or more data elements in the new data block;
a flag field, wherein the flag indicates the one or more data elements of the new data block has a match in the related reference data block,
an index field, wherein the index field indicates the starting position of the one or more matched data elements in the related reference data block; and
a length field, wherein the length field indicates the total length of the matched one or more data elements.

6. The system of claim 1, wherein the compressed delta comprises:
an offset field, wherein the offset field indicates the position of the data word of the new data block;
a flag field, wherein the flag field indicates that the data word of the new data block has no match in the related reference data block; and
a miss field, wherein the miss field records the data word of the new data block.

7. A method comprising:
retrieving, by a delta compression engine, a reference data block from a dictionary module;
receiving, by the delta compression engine, a new data block;
scanning, by the delta compression engine, the reference data block and the new data block to determine a match between one or more data elements of the reference data block and one or more data elements of the new data block;
encoding, by the delta compression engine, based on the determination, the one or more data elements of the new data block to produce a compressed delta; and
storing, by the delta compression engine, the compressed delta and a pointer to the reference data block.

8. The method of claim 7, comprising:
receiving, by the delta compression engine, a reference data block and a signature sketch of the reference data block; and
storing, by the delta compression engine, into the dictionary module, the reference data block and the signature sketch of the reference data block.

9. The method of claim 8, comprising:
receiving, by the delta compression engine, a signature sketch of the new data block.

10. The method of claim 9, wherein retrieving the reference data block from the dictionary module is responsive to searching the dictionary using the signature sketch of the new data block to determine a related signature sketch of a reference data block and determining that a similarity between the signature sketch of the new data block and the determined related signature sketch of a reference data block exceeds a threshold.

11. The method of claim 7, wherein scanning the reference data block and the new data block comprises sequentially searching the location of a next data word of the reference data block and the location of a next data word of the new data block responsive to determining a match between a prior adjacent data word of the reference data block and a prior adjacent data word of the new data block.

12. The method of claim 11, wherein scanning the reference data block and the new data block comprises searching based on a value of a next data word of the new data block responsive to determining a prior adjacent data word of the new data block and a prior adjacent data word of the reference data block do not match.

13. The method of claim 7, wherein the compressed delta comprises one or more sets of one of two combinations of fields of encoded information, one combination of fields is the encoded output for matched data elements, the other combination of fields is the encoded output of a data word in the new data block that has no match among the data elements of the reference data block.

14. The method of claim 13, wherein the combination of fields for matched data elements comprises:
an offset field, wherein the offset indicates the ending position of one or more data elements of the new data block;
a flag field, wherein the flag indicates whether a currently scanned one or more data elements of the new data block has a match in the reference data block;
an index field, wherein the index field indicates the starting position of a currently matched one or more data in the reference data block; and
a length field, wherein the length field indicates the total length of the matched one or more data elements.

15. The method of claim 13, wherein the combination of fields for non-matched data elements comprises:
an offset field, wherein the offset field indicates the ending position of one or more data elements of the new data block;
a flag field, wherein the flag field indicates whether a currently scanned one or more data elements of the new data block has a match in the reference data block; and
a miss field, wherein the miss field records the one or more data elements of the new data block currently scanned which do not appear in the reference data block.

16. A method comprising:
storing, by a delta compression engine, into a reference list, a plurality of reference data blocks and a corresponding reference fingerprint sketch of each of the plurality of reference data blocks;
receiving, by the delta compression engine, a new data block and a new fingerprint sketch corresponding to the new data block;
searching, by the delta compression engine, using the new fingerprint sketch, the reference list to determine a related reference fingerprint sketch;
retrieving, by the delta compression engine, from the reference list, a related reference data block corresponding to the related reference fingerprint sketch responsive to determining that a similarity between the new fingerprint sketch and the related reference fingerprint sketch exceeds a threshold;
scanning, by the delta compression engine, the related reference data block and the new data block to determine a match between one or more data elements of the related reference data block and one or more data elements of the new data block;
encoding, by the delta compression engine, the one or more data elements of the new data block using the match to produce a compressed delta; and
sending, by the delta compression engine, to a data store, the compressed delta and a pointer to the related reference data block.

17. The method of claim 16, further comprising:
generating a hash of the reference fingerprint sketch; and
building a hash index table of hash records, wherein each hash record includes a hash key of a corresponding reference fingerprint sketch and an index to the reference fingerprint sketch location in the reference list.

18. The method of claim 16, wherein storing the reference data blocks comprises:
selecting the reference data blocks for storing based on recency of data content and access frequency.

19. The method of claim 16, wherein searching to determine a related reference fingerprint sketch comprises:
using the new fingerprint sketch as a key to search the reference list.

20. The method of claim 16, wherein determining that a similarity between the new fingerprint sketch and the related reference fingerprint sketch exceeds a threshold comprises:
determining whether the new data block and the related reference data block have more than a threshold number of matched fingerprints between the fingerprint sketches of the new data block and the fingerprint sketch of the reference data block.

21. The method of claim 16, wherein scanning the related reference data block and the new data block to determine a match comprises:
comparing the one or more data elements of the related reference data block and the one or more new data block to determine an identical match; and
responsive to determining an identical match, sequentially searching the related reference data block and the new data block to determine a length of the identical match.

22. The method of claim 21, wherein the compressed delta comprises:
an offset field, wherein the offset indicates the ending position of the matched one or more data elements in the new data block;
a flag field, wherein the flag indicates the one or more data elements of the new data block has a match in the related reference data block;
an index field, wherein the index field indicates the starting position of the one or more matched data elements in the related reference data block; and
a length field, wherein the length field indicates the total length of the matched one or more data elements.

23. The method of claim 21, wherein the compressed delta comprises:
an offset field, wherein the offset field indicates the position of the data word of the new data block;
a flag field, wherein the flag field indicates that the data word of the new data block has no match in the related reference data block; and
a miss field, wherein the miss field records the data word of the new data block.
